(19) United States
(12) Patent Application Publication
(10) Pub. No.: US 2020/0256223 A1
(43) Pub. Date: Aug. 13, 2020

(54) ABNORMALITY DETERMINATION DEVICE OF INTERNAL COMBUSTION ENGINE

(71) Applicant: HONDA MOTOR CO., LTD., Tokyo (JP)

(72) Inventors: Toru Sekiguchi, Wako-shi (JP); Takashi Konomoto, Wako-shi (JP); Masahiro Fujii, Wako-shi (JP)

(73) Assignee: HONDA MOTOR CO., LTD., Tokyo (JP)

(21) Appl. No.: 16/783,796

(22) Filed: Feb. 6, 2020

(30) Foreign Application Priority Data
Feb. 8, 2019 (JP) 2019-021326

(51) Int. Cl. F01M 11/10; F02M 25/06; F02M 35/10

(52) U.S. Cl. CPC F01M 11/10; F02M 25/06; F01M 2013/0038; F02M 35/10386; F02M 35/10222

(57) ABSTRACT

An abnormality determination device of an internal combustion engine in which a breather line connects an intake-air path positioned upstream from a forced-induction system and a crankcase includes an intake-air flow rate sensor that detects an intake air flow rate in the intake-air path, a pressure sensor that detects a pressure in the breather line, and an abnormality determination unit that determines abnormality of the breather line. The abnormality determination unit compares the pressure and a threshold for each flow rate, integrates a number of times the pressure becomes the threshold or greater, and determines abnormality of the breather line when an integrated value becomes a predetermined value or greater within a predetermined time. The abnormality determination unit calculates a weight coefficient for each flow rate and assigns weights to a number of times the pressure becomes the threshold or greater by using the weight coefficient.

### CROSS REFERENCES TO RELATED APPLICATIONS

The present application claims priority under 35 U.S.C. § 119 to Japanese Patent Application No. 2019-021326, filed Feb. 8, 2019, entitled “Abnormality Determination Device of Internal Combustion Engine.” The contents of this application are incorporated herein by reference in their entirety.

### TECHNICAL FIELD

The present disclosure relates to an abnormality determination device of an internal combustion engine in which an intake-air path positioned upstream from a forced-induction system and a crankcase are connected to each other by a breather line.

### BACKGROUND

A method that is employed by such an abnormality determination device of an internal combustion engine is known from U.S. Patent Application Publication No. 2016/0097355A1. In the method, in a state where an internal combustion engine is under high load conditions under which the flow rate of intake air in an intake-air path is equal to or greater than a predetermined flow rate, the integrated value of an estimated pressure in a breather line over a predetermined period of time when the breather line is in a normal state and the integrated value of the actual pressure in the breather line over a predetermined period of time that is detected by a pressure sensor are calculated, and when the ratio of the integrated value of the actual pressure to the integrated value of the estimated pressure is equal to or less than a threshold, it is determined that a connecting portion of the breather line is disconnected.

With the above-mentioned method of the related art, it takes time to perform abnormality determination because it is necessary to integrate, over a relatively long period of time, each of the actual pressure and the estimated pressure of the breather line, and in addition, there is a possibility that the accuracy of the abnormality determination will deteriorate when the correspondence relationship between the actual pressure and the estimated pressure varies due to offset of the output of the pressure sensor.

### SUMMARY

The present application describes, for example, an abnormality determination device of an internal combustion engine that determines abnormality of a breather line of the internal combustion engine in a short time with high accuracy.

One aspect of an abnormality determination device of an internal combustion engine according to the present disclosure in which an intake-air path positioned upstream from a forced-induction system and a crankcase are connected to each other by a breather line includes an intake-air flow rate sensor that detects the flow rate of intake air in the intake-air path, a pressure sensor that detects a pressure of the breather line, and an abnormality determination unit that determines abnormality of the breather line. The abnormality determination unit compares the pressure for each intake air flow rate with a threshold for each intake air flow rate, integrates a number of times the pressure becomes equal to or greater than the threshold, and determines abnormality of the breather line when an integrated value becomes equal to or greater than a predetermined value within a predetermined period of time. Therefore, abnormality of the breather line may be determined with high accuracy in a short time.

In the abnormality determination device of an internal combustion engine according to the present disclosure, the abnormality determination unit may calculate a weight coefficient for each intake air flow rate and assign weights to a number of times the pressure becomes equal to or greater than the threshold by using the weight coefficient. Therefore, the integrated value when the internal combustion engine is under high load conditions, under which the intake air flow rate increases and under which the determination accuracy is improved, may be increased, and more accurate determination results may be obtained in a shorter time. In addition, abnormality determination is less likely to be influenced by offset of the output of the pressure sensor, and the determination accuracy may be improved.

Note that an airflow meter 16 according to an embodiment of the present disclosure corresponds to the intake-air flow rate sensor according to the present disclosure.

### BRIEF DESCRIPTION OF THE DRAWINGS

The advantages of the disclosure will become apparent in the following description taken in conjunction with the following drawings.

FIG. 1 is a diagram illustrating a configuration of an internal combustion engine that includes an abnormality determination device for a breather line of one embodiment.

FIG. 2 is a block diagram of the abnormality determination device for the breather line of one embodiment.

FIG. 3 is a graph illustrating a relationship between the flow rate of intake air in an intake-air path, the pressure in the breather line, and a weight coefficient of one embodiment.

FIG. 4 is a diagram illustrating the principle of determination of abnormality of the breather line of one embodiment.

FIG. 5 is a flowchart illustrating an operation of the abnormality determination device for the breather line of one embodiment.

### DETAILED DESCRIPTION

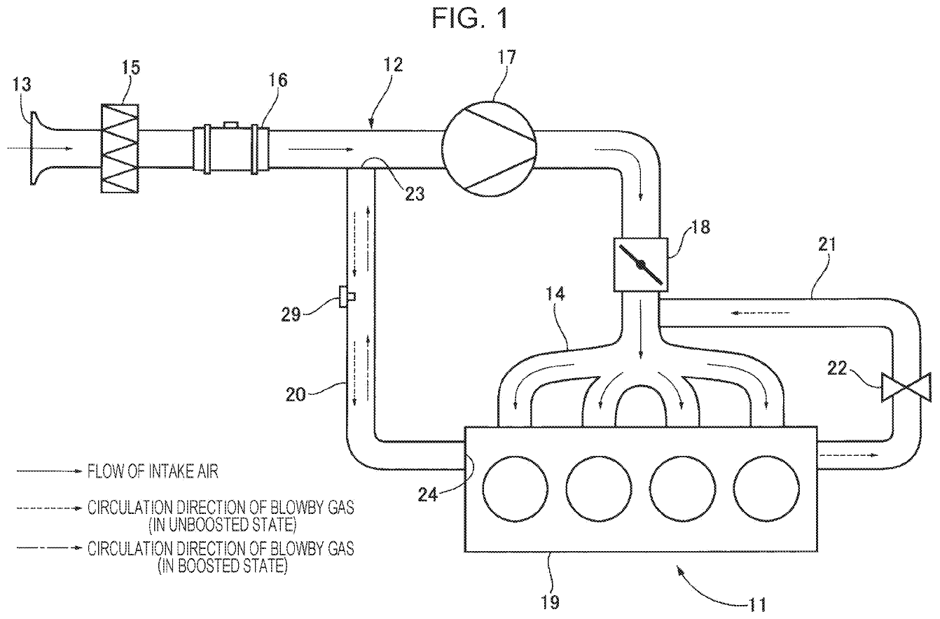

An embodiment of the present disclosure will be described below with reference to FIG. 1 to FIG. 5.

As illustrated in FIG. 1, on an intake-air path 12 of an in-line four-cylinder four-cycle internal combustion engine 11 that is mounted on an automobile, an air cleaner 15 that removes dust contained in intake air, an airflow meter 16 that measures the flow rate of the intake air, a forced-induction system 17 that is formed of a turbocharger or a supercharger that pressurizes the intake air, and a throttle valve 18 that adjusts the flow rate of the intake air by reducing the diameter of the intake-air path 12 are arranged in this order in a direction from an intake port 13 toward an intake manifold 14, the intake port 13 being positioned at the upstream end in a flow direction of the intake air, and the intake manifold 14 being positioned at the downstream end in the flow direction of the intake air. A portion of the intake-air path 12 that is located between the airflow meter 16 and the forced-induction system 17 and a crankcase 19 of the internal combustion engine 11 are connected to each other by a breather line 20. In addition, the intake manifold 14 and the crankcase 19 of the internal combustion engine 11 are connected to each other by a positive crankcase ventilation (PCV) line 21, and a PCV valve 22 opens and closes an intermediate portion of the PCV line 21.

Blowby gas that is a portion of a fuel component contained in intake air, the portion having flowed in the crankcase 19 from a combustion chamber of the internal combustion engine 11 by passing through a gap between a piston and a cylinder, is caused to return to the intake-air path 12 through the breather line 20 or caused to return to the intake-air path 12 through the PCV line 21, so that the fuel component contained in the blowby gas is prevented from being released to an atmosphere.

In other words, when the PCV valve 22 is opened in a state where the internal combustion engine 11 is in an unboosted state in which the forced-induction system 17 does not operate, atmospheric pressure acts on a portion of the intake-air path 12 that is positioned upstream from the throttle valve 18, and in contrast, the intake negative pressure of the internal combustion engine 11 acts on a portion of the intake-air path 12 that is positioned downstream from the throttle valve 18. Thus, the intake air in the intake-air path 12 positioned upstream from the throttle valve 18 flows into the crankcase 19 through the breather line 20, and then, the intake air is returned to the intake manifold 14 through the PCV line 21 together with the blowby gas and is finally supplied to the combustion chamber of the internal combustion engine 11 together with the intake air.

When the internal combustion engine 11 is in a boosted state in which the forced-induction system 17 operates, although boost pressure acts on the portion of the intake-air path 12 positioned downstream from the forced-induction system 17, closing the PCV valve 22 prevents the boost pressure from escaping to the crankcase 19 through the PCV line 21. The blowby gas in the crankcase 19 is drawn into the intake-air path 12 by a negative pressure that is generated on the upstream side of the forced-induction system 17, which is operating. Then, the blowby gas passes through the intake-air path 12 together with the intake air and is supplied to the combustion chamber of the internal combustion engine 11.

When the internal combustion engine 11 is in the boosted state, for example, if a first connection portion 23 of the breather line 20 that is to be connected to the intake-air path 12 is disconnected from the intake-air path 12, or if a second connection portion 24 of the breather line 20 that is to be connected to the crankcase 19 is disconnected from the crankcase 19, there is a possibility that blowby gas flowing through the breather line 20 from the crankcase 19 toward the intake-air path 12 will be released to the atmosphere, and thus, it is necessary to detect abnormality of the breather line 20 and to issue a warning. Accordingly, the breather line 20 is provided with a pressure sensor 29 that detects the pressure in the breather line 20.

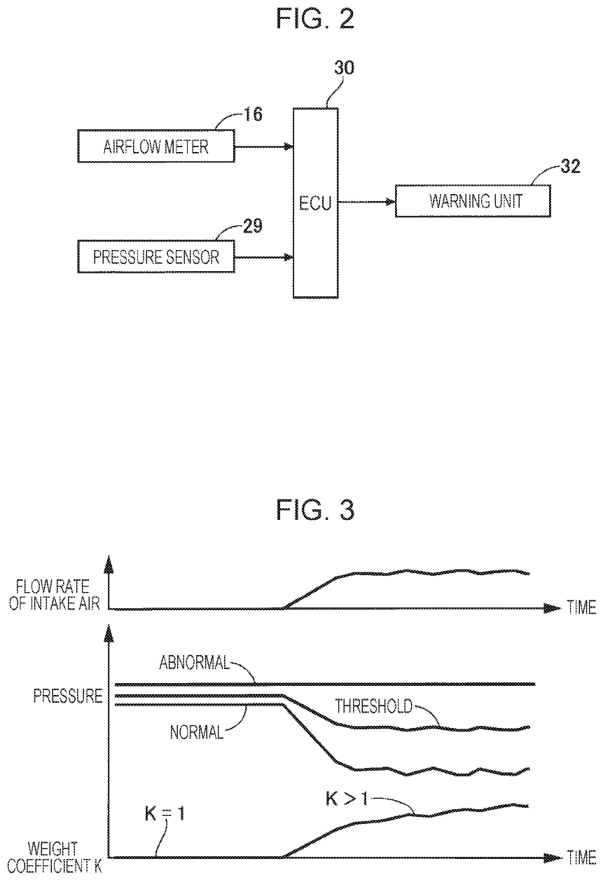

As illustrated in FIG. 2, an abnormality determination unit 30 that is formed of an electronic control unit that determines abnormality of the breather line 20 is connected to the airflow meter 16, the pressure sensor 29, and a warning unit 32. The warning unit 32 is formed of, for example, a liquid crystal panel that is included in an instrument panel.

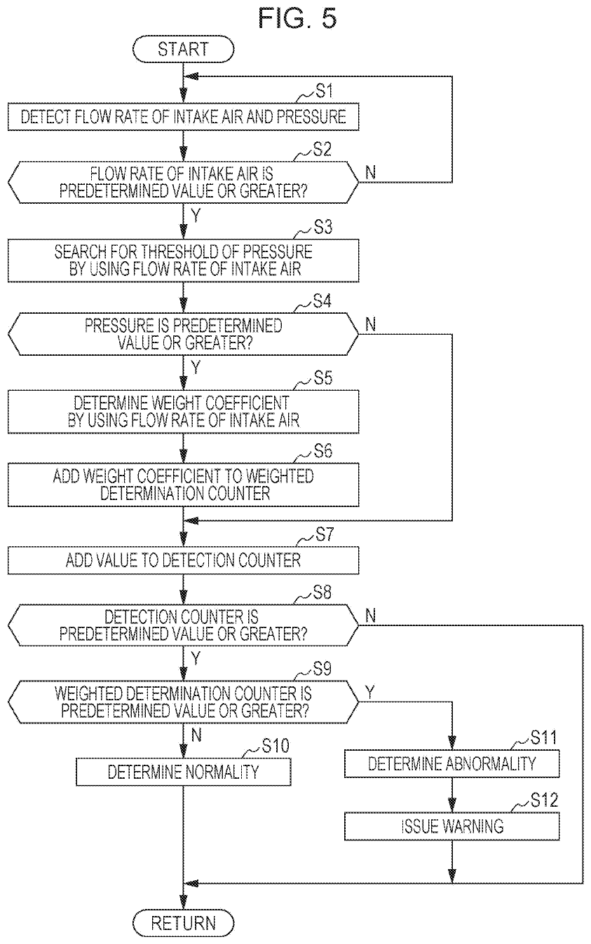

Next, steps for determining abnormality of the breather line 20 that are performed by the abnormality determination unit 30 will be described with reference to the flowchart illustrated in FIG. 5.

First, in step S1, the air flow meter 16 detects the flow rate of the intake air in the intake-air path 12, and the pressure sensor 29 detects the pressure in the breather line 20. Subsequently, in step S2, if the intake air flow rate is equal to or greater than a predetermined value, and the internal combustion engine 11 is in a predetermined high-load operation state, a threshold of the pressure is map-searched by using the intake air flow rate in step S3.

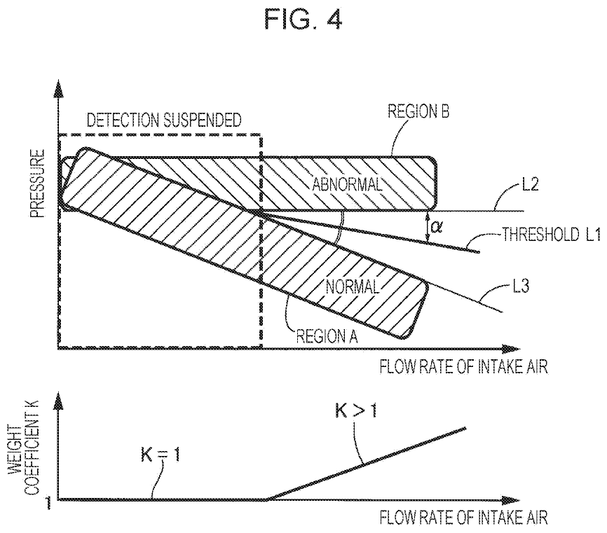

The threshold of the pressure is set in the following manner. In FIG. 3 and FIG. 4, in a normal state in which there is no leak in the breather line 20, when the pressure in the breather line 20 is detected for various intake air flow rates of the intake-air path 12, the data values of the detected pressure congregate in a region A due to, for example, a detection error of the pressure sensor 29. The region A has a shape that extends obliquely downward to the right-hand side because, if the intake air flow rate increases when the breather line 20 is in the normal state, the pressure in the breather line 20 decreases as a result of the intake negative pressure increasing with the increase in the intake air flow rate.

In an abnormal state in which leakage has occurred in the breather line 20, when the pressure in the breather line 20 is detected for various intake air flow rates of the intake-air path 12, the data values of the detected pressure congregate in a region B due to, for example, a detection error of the pressure sensor 29. The region B has a shape that extends horizontally because, even if the intake air flow rate increases when the breather line 20 is in the abnormal state, and the intake negative pressure increases, the pressure in the breather line 20 that is in communication with the atmosphere decreases to only a small extent.

A threshold line L1 in the map is set to extend midway between a lower limit line L2 of the region B and an upper limit line L3 of the region A. Thus, when the pressure value detected by the pressure sensor 29 is below the threshold line L1, the breather line 20 is tentatively presumed to be in the normal state, and when the pressure value detected by the pressure sensor 29 is above the threshold line L1, the breather line 20 is tentatively presumed to be in the abnormal state.

Returning to the flowchart illustrated in FIG. 5, if the pressure in the breather line 20 detected by the pressure sensor 29 is equal to or greater than the threshold, and the breather line 20 is tentatively presumed to be in the abnormal state in step S4, a weight coefficient K is map-searched by using the intake air flow rate in step S5.

The map of the weight coefficient K is set in the following manner. As illustrated in FIG. 3 and FIG. 4, the weight coefficient K is set in a high-load region of the internal combustion engine 11 where the threshold line L1 of the pressure is set, and its value is set so as to increase from 1 as a distance a between the threshold line L1 of the pressure and the lower limit line L2 of the region B increases. In other words, the weight coefficient K increases from 1 as the intake air flow rate increases.

Returning to the flowchart illustrated in FIG. 5, after a search has been performed for the weight coefficient K in step S5, the weight coefficient K is added to a weighted determination counter in step S6. When the weight coefficient K is 1 because the intake air flow rate is small, the value that is added to the weighted determination counter in the calculation loop is 1. When the weight coefficient K is greater than 1 because the intake air flow rate is large, the value that is added to the weighted determination counter in the calculation loop is a value greater than 1.

Thus, if the breather line 20 is tentatively presumed to be in the abnormal state when the intake air flow rate is large, the integrated value of the weighted determination counter increases more rapidly than the integrated value when the intake air flow rate is small does. This setting is employed in order to increase the weight coefficient K when the internal combustion engine 11 is under high load conditions, under which the intake air flow rate is large, and in order to add the weight coefficient K to the weighted determination counter because, the pressure changes more greatly with changes in the intake air flow rate, and the determination accuracy is further improved as the internal combustion engine 11 is under higher load conditions, under which the intake air flow rate is large.

Subsequently, in step S7, 1 is added to a detection counter to which a value is added for each calculation loop. If the pressure in the breather line 20 detected by the pressure sensor 29 in step S4 is less than the threshold, and the breather line 20 is tentatively presumed to be in the normal state, the process skips step S5 and step S6 and proceeds to step S7.

Subsequently, after the integrated number of the detection counter has become equal to or greater than a predetermined value, and calculation loops has been performed as many times as necessary to perform accurate determination in step S8, if the integrated value of the weighted determination counter is less than a predetermined value in step S9, it is ultimately determined that the breather line 20 is in the normal state in step S10. In contrast, if the integrated value of the weighted determination counter is equal to or greater than the predetermined value in step S9, it is ultimately determined that the breather line 20 is in the abnormal state in step S11, and the warning unit 32 is activated so as to issue a warning to an occupant in step S12.

As described above, according to the present embodiment, if the proportion of the period of time over which the breather line 20 is presumed to be in the abnormal state to a predetermined period of time over which the detection counter performs detection is equal to or greater than a predetermined value, it is ultimately determined that the breather line 20 is in the abnormal state. Conversely, the proportion of the period of time over which the breather line 20 is presumed to be in the normal state to the predetermined period of time over which the detection counter performs detection is equal to or greater than the predetermined value, it is ultimately determined that the breather line 20 is in the normal state. Thus, abnormality determination is less likely to be influenced by offset of the output of the pressure sensor 29, and determination of abnormality of the breather line 20 can be completed with high accuracy in a short time of about 2 to 10 seconds.

In addition, as the internal combustion engine 11 is under higher load conditions, under which the determination accuracy is high because the intake air flow rate is large, the weight coefficient K is increased and added to the weighted determination counter, and thus, abnormality determination can be completed with higher accuracy in a shorter time.

Although the embodiment of the present disclosure has been described above, various design changes can be made within the gist of the present disclosure.

For example, the number of cylinders of the internal combustion engine 11 is not limited to four, which is mentioned in the embodiment.

In addition, in the embodiment, although the breather line 20 is connected to the crankcase 19, the advantageous effects of the present disclosure can also be obtained by causing the internal space of the crankcase 19 and the internal space of a head cover to communicate with each other and by connecting the breather line 20 to the head cover. Therefore, such a configuration in which the breather line 20 is connected to another space that is in communication with the crankcase 19 is also included in the technical scope of the present disclosure. Although a specific form of embodiment has been described above and illustrated in the accompanying drawings in order to be more clearly understood, the above description is made by way of example and not as limiting the scope of the invention defined by the accompanying claims. The scope of the invention is to be determined by the accompanying claims. Various modifications apparent to one of ordinary skill in the art could be made without departing from the scope of the invention. The accompanying claims cover such modifications.

What is claimed is:

1. An abnormality determination device of an internal combustion engine in which a crankcase and an intake-air path positioned upstream from a forced-induction system are connected to each other by a breather line, the abnormality determination device comprising:
an intake-air flow rate sensor that detects a flow rate of intake air in the intake-air path;
a pressure sensor that detects a pressure in the breather line; and
an abnormality determination unit that determines abnormality of the breather line,
wherein the abnormality determination unit:
compares the pressure of the breather line with a threshold, the threshold being associated with a value of the intake-air flow rate detected at the time when the pressure being detected,
integrates a number of times the pressure becomes equal to or greater than the threshold to obtain an integrated value, and
determines occurrence of abnormality of the breather line when the integrated value becomes equal to or greater than a predetermined value within a predetermined period of time.

2. The abnormality determination device of an internal combustion engine according to claim 1,
wherein the abnormality determination unit calculates a weight coefficient associated with the value of the intake-air flow rate detected at the time when the pressure being detected and assigns weights to a number of times the pressure becomes equal to or greater than the threshold by using the weight coefficient.

3. The abnormality determination device of an internal combustion engine according to claim 1,
wherein the weight coefficient increases as the intake-air flow rate increases.

4. An abnormality determination method of an internal combustion engine in which a crankcase and an intake-air path positioned upstream from a forced-induction system are connected to each other by a breather line, the method comprising steps of:
detecting by an intake-air flow rate sensor a flow rate of intake air in the intake-air path;
detecting by a pressure sensor a pressure in the breather line;
comparing by a computer the pressure of the breather line with a threshold, the threshold being associated with a value of the intake-air flow rate detected at the time when the pressure being detected;
integrating by the computer a number of times the pressure becomes equal to or greater than the threshold to obtain an integrated value; and
determining by the computer occurrence of abnormality of the breather line when the integrated value becomes equal to or greater than a predetermined value within a predetermined period of time.
